(19) United States
(12) Patent Application Publication
(10) Pub. No.: US 2008/0100997 A1
(43) Pub. Date: May 1, 2008

(54) Monitor turnning device

(75) Inventor: Hwa-Lo Chen, Taipei City (TW)

Correspondence Address: HWA-LO CHEN, P.O. Box 44 - 2049, Taipei, 10668, omitted

(73) Assignee: CHUN-CHIEH LIAO

(21) Appl. No.: 11/589,250

(22) Filed: Oct. 30, 2006

(51) Int. Cl. G06F 1/16

(52) U.S. Cl. 361/681; 248/917

(57) ABSTRACT

A monitor turning device includes a base with a box connected thereon and a gear unit is received in the box and driven by a driving member. The gear unit includes a pivotable output gear which has two output members. A disk unit includes a first disk located on a top of the box and a second disk is overlapped on the first disk with a friction-reduction member located therebetween. The connection members extend through slots defined in the box and the first disk and are connected to the second disk. A monitor is connected to the second disk by a frame so that when the output gear is pivoted, the second disk together with the monitor is rotated an angle. The driving member can be controlled by remote control.

### BACKGROUND OF THE INVENTION

(1) Field of the Invention

The present invention relates to a monitor turning device to turn the monitor within a pre-set range by a driving member which is cooperated with a gear unit.

(2) Description of the Prior Art

A conventional monitor set 40 generally includes a support base 401 which supports a monitor 402 or an LCD television as shown in FIG. 1 and the monitor 402 generally is able to turn an angle when needed. The user has to move toward the monitor 402 to adjust it by hand and then move back to check if the position of the monitor 402 meets the requirement of the user. However, the user has to adjust the monitor 402 several times to find out which direction is what the user really wants the monitor to face.

The present invention intends to provide a monitor turning device which includes a driving member to drive a gear unit so as to adjust the monitor without actually touching the monitor.

### SUMMARY OF THE INVENTION

The present invention relates to a monitor turning device which comprises a base having a box connected thereon which has a space for receiving a driving member and a gear unit therein. The gear unit includes two first gears, a turning gear, a mediate gear, a speed reduction gear and an output gear. Two output members are connected to the output gear and extend through two first slots defined through a top of the box. A shaft extends through the output gear so that the output gear is pivotable about the shaft. A disk unit has a first disk located on a top of the box and a second disk is overlapped on the first disk with a friction-reduction member located therebetween. The connection members extend through slots in the first disk and are connected with the second disk. A plurality of connection members extend through slots defined in the first disk and are connected to engaging holes in the second disk. The shaft extends through the first and second disks. The monitor is connected to the second disk by a frame.

The primary object of the present invention is to provide a monitor turning device which includes a driving member cooperated with a gear unit so as to adjust the monitor without physically touching the monitor by the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a monitor supported on a conventional base;

FIG. 2 is an exploded view to show the monitor turning device of the present invention;

FIG. 3 is a perspective view to show that the driving member and the gear unit are received in the box of the present invention;

FIG. 4 shows a frame is connected to the second disk so as to be connected with a monitor;

FIG. 5 is a top view to show the monitor turning device of the present invention;

FIGS. 6 and 7 show the pivotable output gear is pivoted in two different directions when the driving member rotates in different directions, and

FIG. 8 shows that the monitor is rotated an angle in two directions.

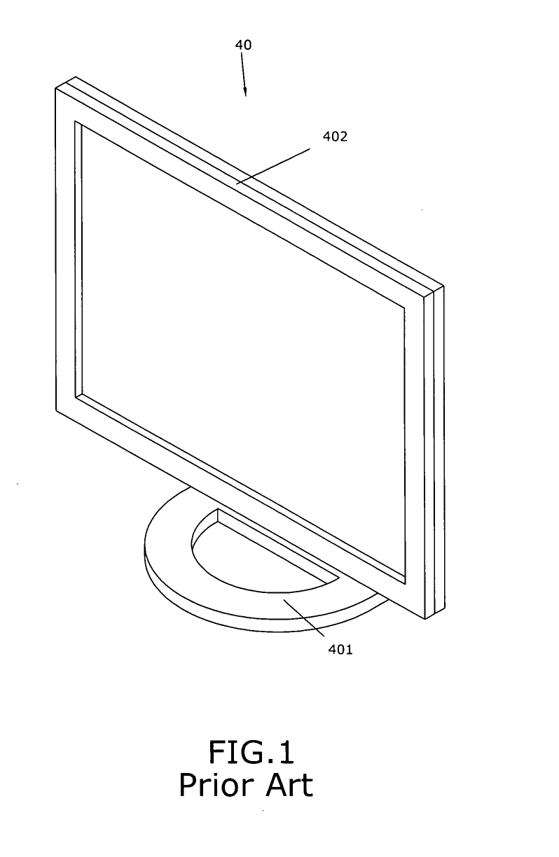

### DETAILED DESCRIPTION OF THE PREFERRED EMBODIMENTS

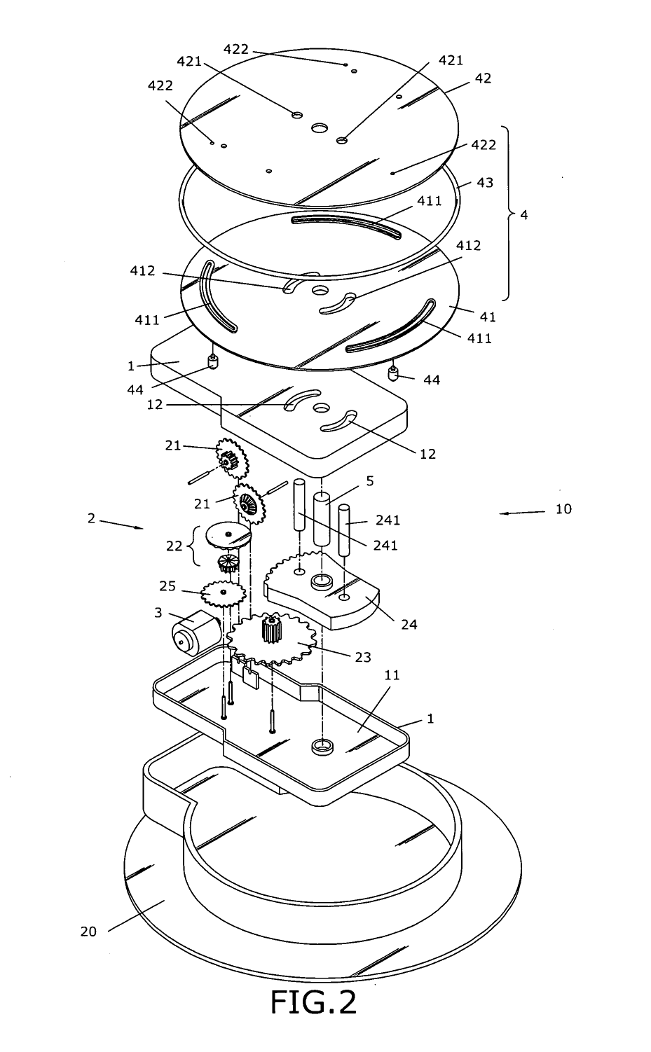

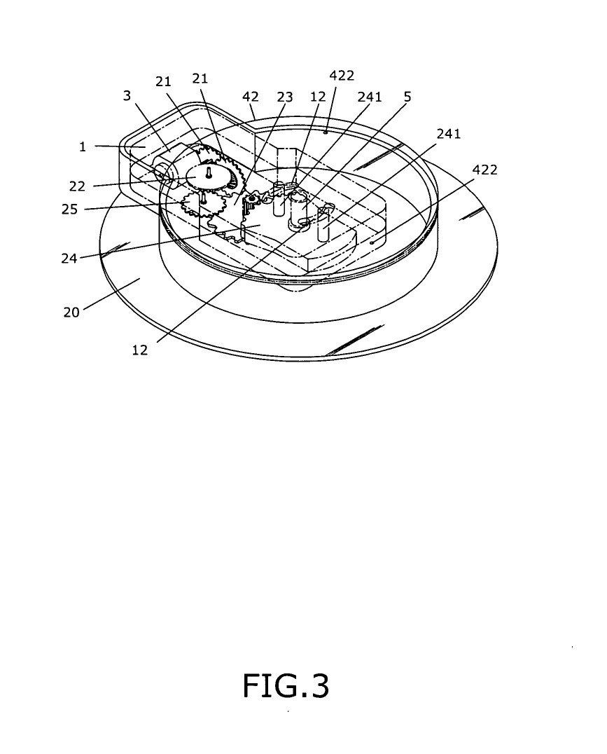

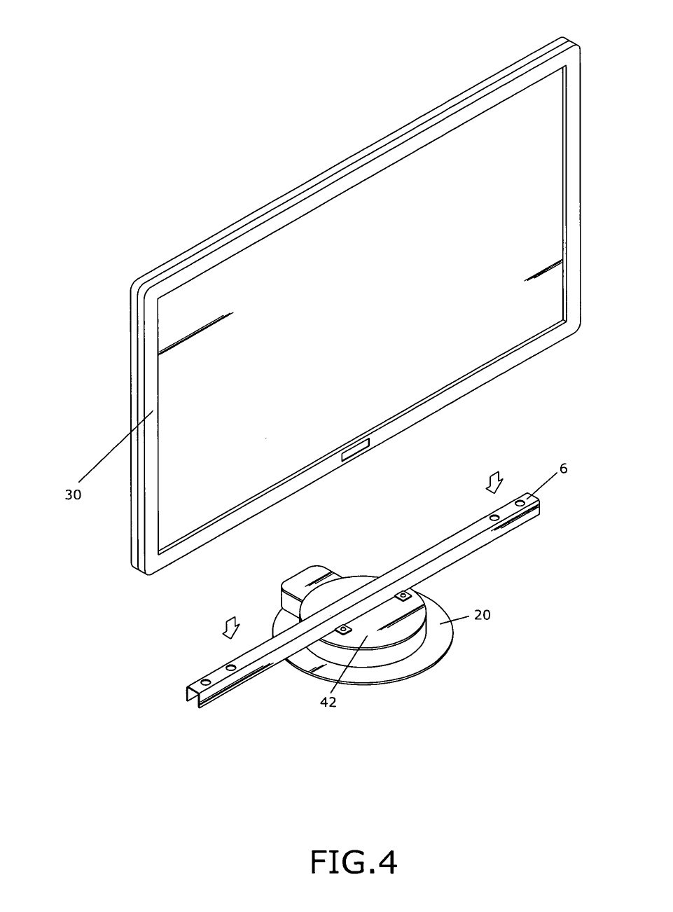

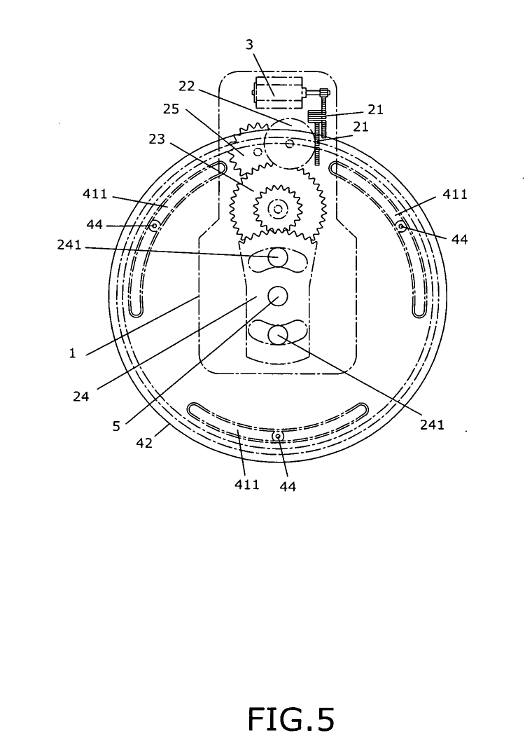

Referring to FIGS. 2 to 5, the monitor turning device 10 of the present invention comprises a base 20 having a box 1 connected thereon and the box 1 has a space 11 defined therein so as to receive a driving member 3 and a gear unit 2 therein. The gear unit 2 is received in the space 11 of the box 1 and includes two first gears 21, a turning gear 22, a mediate gear 25, a speed reduction gear 23 and an output gear 24. The two first gears 21 are engaged with each other and one of the two first gears 21 is driven by the driving member 3. The turning gear 22 is engaged with the other one of the first gears 21 and mediate gear 25 is engaged with the turning gear 22. The speed reduction gear 23 is engaged with the mediate gear 25. The speed reduction gear 23 is engaged with the output gear 24 which has two output members 241 connected thereto. The output gear 24 is a rectangular member and has teeth defined in an end thereof and the teeth are engaged with the speed reduction gear 23. The two output members 241 are two cylindrical rods and extend through first slots 12 defined through a top of the box 1. A shaft 5 extends through the output gear 24 and the top of the box 1 so that the output gear 24 is pivotable about the shaft 5.

A disk unit 4 has a first disk 41 located on a top of the box 1 and a plurality of second slots 411 defined through the first disk 41. A plurality of third slots 412 are defined through the first disk 41 and the two output members 241 extend through the third slots 412. A second disk 42 overlaps on the first disk 41 with a ring-shaped friction-reduction member 43 located between the first and second disks 41, 42. The second disk 42 has two connection holes 421 and a plurality of engaging holes 422. The two output members 241 are engaged with the two connection holes 421. A plurality of connection members 44 extend through the second slots 411 and are connected to engaging holes 422 in the second disk 42. The shaft 5 extends through the first and second disks 41, 42. A frame 6 is fixed on the second disk 42 so as to be connected to a monitor 30.

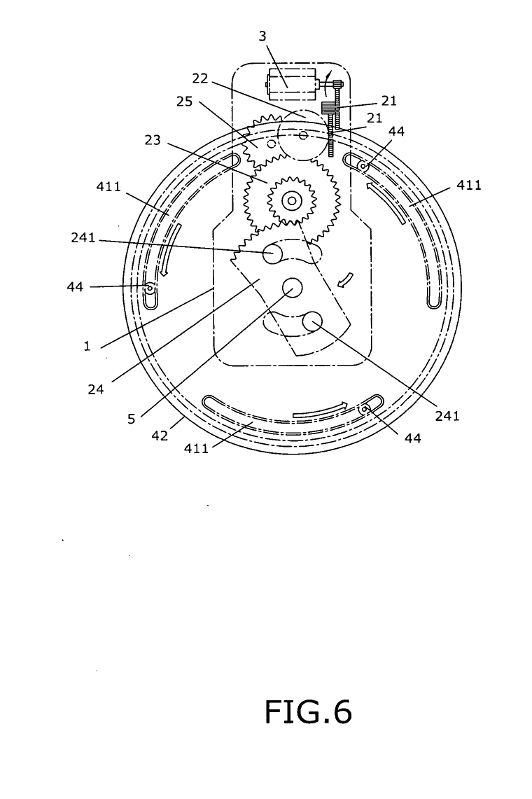

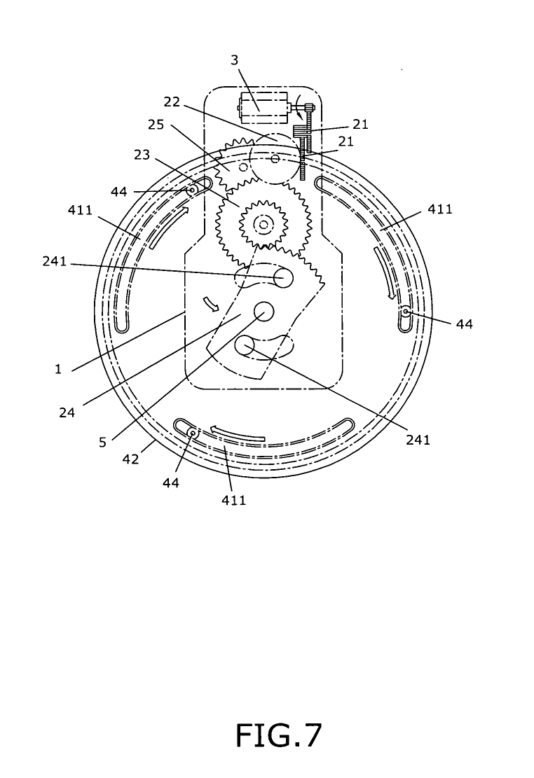

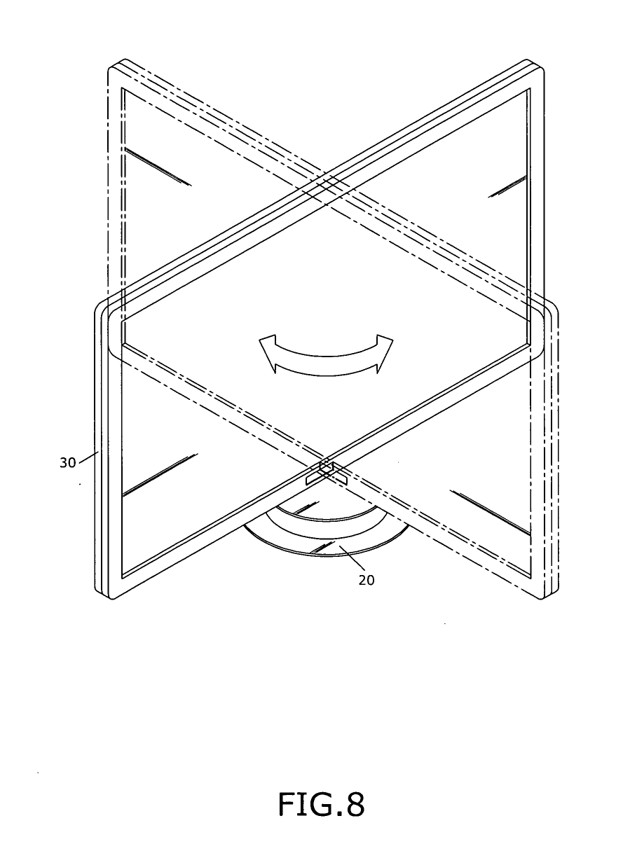

As shown in FIG. 6, when the driving member 3 rotates the first gear 21 clockwise, the output gear 24 is pivoted counter clockwise, so that the second disk 42 is rotated counter clockwise. On the contrary, as shown in FIG. 7, when the driving member 3 rotates the first gear 21 counter clockwise, the output gear 24 is pivoted clockwise, so that the second disk 42 is rotated clockwise.

The driving member 3 can be a motor and controlled by a remote control so that the user can adjust the monitor at a distance. The first slots 12 restrict the angle that the two output members 241 rotate so that the monitor 30 is not rotated overly.

While we have shown and described the embodiment in accordance with the present invention, it should be clear to those skilled in the art that further embodiments may be made without departing from the scope of the present invention.

What is claimed is:

1. A monitor turning device comprising:
a base having a box connected thereon and the box having a space defined therein, two first slots defined through a top of the box;
a gear unit received in the space of the box and including two first gears, a turning gear, a mediate gear, a speed reduction gear and an output gear, two output members connected to the output gear and extending through the first slots, a shaft extending through the output gear so that the output gear being pivotable about the shaft;
a driving member received in the space of the box and engaged with the gear unit;
a disk unit having a first disk located on a top of the box and a plurality of second slots defined through the first disk, a plurality of third slots defined through the first disk and the two output members extending through the third slots, a second disk overlapping on the first disk with a friction-reduction member located between the first and second disks, the second disk having two connection holes and a plurality of engaging holes, the two output members engaged with the two connection holes, a plurality of connection members extending through the second slots and connected to engaging holes in the second disk, the shaft extending through the first and second disks, and
a frame fixed on the second disk so as to be adapted to be connected to a monitor.

2. The device as claimed in claim 1, wherein the output gear is a rectangular member and has teeth defined in an end thereof and the teeth are engaged with the speed reduction gear.

3. The device as claimed in claim 1, wherein the two output members are two cylindrical rods.

4. The device as claimed in claim 1, wherein the friction-reduction member is a ring.
